(19) United States
(12) Patent Application Publication
(10) Pub. No.: US 2024/0311771 A1
(43) Pub. Date: Sep. 19, 2024

(54) SYSTEM AND METHOD FOR LOCATING AND MATCHING IN EMPLOYMENT RELATIONSHIPS

(71) Applicant: Go2Work, Inc., Chattanooga, TN (US)

(72) Inventor: William Timothy Payne, Chattanooga, TN (US)

(73) Assignee: Go2Work, Inc., Chattanooga, TN (US)

(21) Appl. No.: 18/608,272

(22) Filed: Mar. 18, 2024

Related U.S. Application Data
(60) Provisional application No. 63/490,837, filed on Mar. 17, 2023.

(51) Int. Cl. G06Q 10/1053; G06Q 20/10; G06Q 40/12; H04L 67/306

(52) U.S. Cl. CPC G06Q 10/1053; G06Q 20/10; G06Q 40/125; H04L 67/306

(57) ABSTRACT

A computer system and method for connecting individuals in the construction industry, specifically, contractors needing jobs completed and sub-contractors seeking jobs to complete. A contactor will input job details into an interface and a processor will match the job details with the details of profiles associated with sub-contractors. Any information making up the sub-contractor profile is verified by the computer system against third-party databases. A list of suitable sub-contractors is provided and the contractor, using the interface, selects the desired sub-contractor. The sub-contractor is alerted, and the job is scheduled. The details of the job are cataloged in a memory and, when required, a report detailing all jobs completed during a relevant time-period is sent to the various contractors and sub-contractors. The report contains sufficient information for the individual or business to complete its tax return.

### CROSS-REFERENCE TO RELATED APPLICATIONS

This application claims the benefit of U.S. Provisional Application No. 63/490,837 filed Mar. 17, 2023, and entitled System and Method for Locating and Matching in Employment Relationships, which is incorporated herein by reference in its entirety.

### FIELD

The present invention relates generally to methods for locating and matching potential employers with potential employees and for generating and managing certain employment-related relationships, files, and documents, including particularly in the construction industry. More particularly, the present invention relates to systems and methods for locating and matching in employment relationships, including enabling contractors to view available sub-contractors and to post jobs, and also to enable sub-contractors to view jobs and accept work proposals from contractors.

### BACKGROUND

In the United States, the construction industry is large and rapidly expanding. As of May 2021, the U.S. Bureau of Labor statistics estimates that there are almost 6 million sub-contractors in construction and extraction occupations. As the demand for new buildings and renovation of old buildings increases, the need for more construction sub-contractors is also increasing. However, there are a number of issues that can adversely impact employment relations between contractors and sub-contractors. For example, although the demand is prevalent, many contractors have difficulty finding reliable, qualified sub-contractors. Many sub-contractors will accept a job but never report for work or the sub-contractors available for the job are inexperienced. Alternatively, a sub-contractor may fraudulently claim they have insurance, placing the contractor at risk if any accidents occur. These issues can be both costly and frustrating to a contractor on a tight schedule and budget to complete a project. On the other hand, many sub-contractors are hesitant to accept a job if the work scope is not clear. In addition, a sub-contractor may also be worried payment may not be timely made upon completion of the job. Finally, a sub-contractor may be expected to supply certain equipment they do not have, making completion of the job impractical.

An issue common to both contractors and sub-contractors is taxes. Due to the nature of the construction industry (i.e., where contractor typically hire multiple sub-contractors for specific, time-limited jobs several times per year), as tax filing deadlines approach, contractors and sub-contractors may spend a large amount of time gathering all required tax documents. Further, if any provided documentation from a contractor or sub-contractor was incomplete or incorrect, the other might be required to track down the correct information, which could involve locating a former employer or employee. Complicating things more, deductions that are available to certain sub-contractors and contractors require very specific and sometimes hard to obtain documentation.

What is needed, therefore, is a platform to easily connect contractors needing sub-contractors to sub-contractors needing jobs. Further, the platform should be specifically tailored to the demands and realities of the industry in which it is used (e.g., the construction industry). As a specific example, in the construction industry, the platform should be tailored to verify contractor and sub-contractor documentation, require a detailed scope of work when posting jobs, and generate reports containing all relevant tax documentation.

### SUMMARY

The following presents a simplified summary of one or more embodiments of the invention to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing a computer system for facilitating hiring and payment of a sub-contractor. In some embodiments the computer system may comprise an interface and a processor. The interface may be operable to electronically receive inputs form a plurality of sub-contractors to create a plurality of sub-contractor profiles. The subcontractor inputs may comprise basic identification information, relevant tax documentation, an employability status, a skill-set identification including experience levels, relevant licensure documents, and an indication of appropriate travel distance. The interface may also electronically receive inputs from a first user to create a job posting. The user inputs may comprise a scope of work, an experience level requirement, an equipment requirement, and an insurance requirement. The processer may be configured to receive the sub-contractor inputs and the user inputs from the interface. The processer may be further configured to electronically confirm and verify the sub-contractor inputs with a relevant third party. If any sub-contractor inputs are unable to be verified, the processer may refuse creation of the sub-contractor profile until the inputs can be verified. The processer may be configured to alert a second user associated with the sub-contractor profile if any inputs cannot be verified. The processor may be further configured to analyst the job posting to create a list of sub-contractor profiles suitable for the job posting and provide the list to the first user via the interface. If the first user selects an acceptable sub-contractor profile form the list, the processor creates a communication between a third user associated with the sub-contractor profile and the first user. The interface may be further configured to alert the third user of the selection of the first user. The third user then completes a job for the first user based on the job posting.

In certain embodiments, if the acceptable sub-contractor profile is not located or selected, the processor places the job posting on a database for sub-contractors to view via the interface. A fourth user may then express interest in the job positing by sending an alert to the first user via the interface. The first user may then review ta sub-contractor profile of the fourth user and, if the first user finds the fourth user acceptable for the job posting, the processor creates a communication between the fourth user and the first user and sends n alert to the fourth user. The fourth user then completes a job for the first user based on the job posting.

The computer system may further comprise a memory configured to store details about the job completed. After a predetermined period of time, the processor may generate a report including the details about the job completed and the processor may provide the report to any user associated with any job completed. In certain embodiments, the details about the job completed may comprise dates worked, a payment amount, and any expenses associated with the job. In certain embodiments, the report comprises a Form-1099.

In certain embodiments, the processor may be further configured to re-confirm and re-verify the sub-contractor inputs at pre-determined time intervals. If the sub-contractor inputs cannot be re-confirmed or re-verified, the processor sends an alert to the user associated with the sub-contractor profile via the interface. Additionally, the user is unable to interact with the job postings until the inputs are corrected and re-confirmed or re-verified.

In certain further embodiments, the processor of the computer system may further comprise a payment function wherein, upon completion of the job. Monetary funds are transferred from the first user to the third user. In certain embodiments, a portion of the funds are retained by the computer system. In certain further embodiments, the processor may communicate with an escrow account service. The first user, using the interface, may place the monetary funds in the escrow account prior to the start of the job. Upon completion of the job, the funds may be released and subsequently transferred to the third user.

Also disclosed herein is a method for contract job management and documentation. The method comprises a first step of providing a computer system having an interface for providing information to users, an inputs for receiving information from the users, a memory for storing instruction and also for storing information provided to or received from the users, a processor for processing information stored to the memory and for providing instructions and information stored to the memory or that is based on the information stored to the memory and that is provided to the user via the interface. Next, with the computer system, contractor information is received and stored to the memory and a contractor profile is created based on and associated with the contractor information. Next, with the computer system, receiving a contact job description and at least one job requirement for a contract job. The at least one job requirement may include at least one tax-related requirement. The contract job description and at least one job requirement is then associated with the contractor profile. Next, the method may include, with the computer system, receiving and storing to the memory sub-contractor information related to each of a plurality of sub-contractors. For each of the plurality of sub-contractors, a separate sub-contractor profile based on and associated with the sub-contractor information relevant to that sub-contractor is created. The sub-contractor profile includes ate least one job preference.

As a next step in the preferred method, with the computer system, the contractor and plurality of sub-contractors are required to provide information to the computer system necessary for satisfying each of the at least one job requirement including the at least one tax-related requirement. Then, based on the contract description, the sub-contractor profiles, and the at least one job preference, the computer system attempts to match at least one of the plurality of sub-contractors to the contract and, if a match is made between the contractor job and a matching sub-contractor profile, providing the contractor with an identity of the contractor associated with the matching sub-contractor profile. Next, an acceptance indicating that the contractor and one of the matching sub-contractors has agreed to contract for the contract job is received with the computer system. Finally, with the computer system, for each contract where an acceptance has been received, automatically associating information that is received by the system and stored to the memory that is necessary to satisfy the at least one job requirement and the at least one tax-related requirement with at least one of the contractor profile and the sub-contractor profile.

In certain embodiments, the method may further comprise, with the computer system, processing the contract job description in order to determine at least one job requirement, including at least one tax-related requirement, and issuing an instruction requesting information be provided to the computer system related to the at least one job requirement including the at least one tax-related requirement. In certain embodiments, the method may further comprise processing the contract job description in order to identify one of said at least one said job requirement with the computer system. In certain further embodiments, the method may further comprise, with the computer system, after a predetermined time interval, sending a report comprising the associated information stored in the memory to the associated contractor profile or sub-contractor profile.

Also disclosed herein is a method for creating and managing tax documents for contractors in a construction industry comprising the following steps. First, a computer system for facilitating hiring and payment of a sub-contractor is provided. The computer system may comprise an interface and a processor. The interface may be operable to electronically receive inputs form a plurality of sub-contractors to create a plurality of sub-contractor profiles. The subcontractor inputs may comprise basic identification information, relevant tax documentation, an employability status, a skill-set identification including experience levels, relevant licensure documents, and an indication of appropriate travel distance. The interface may also electronically receive inputs from a first user to create a job posting. The user inputs may comprise a scope of work, an experience level requirement, an equipment requirement, and an insurance requirement. The processer may be configured to receive the sub-contractor inputs and the user inputs from the interface. The processer may be further configured to electronically confirm and verify the sub-contractor inputs with a relevant third party. If any sub-contractor inputs are unable to be verified, the processer may refuse creation of the sub-contractor profile until the inputs can be verified. The processer may be configured to alert a second user associated with the sub-contractor profile if any inputs cannot be verified. The processor may be further configured to analyst the job posting to create a list of sub-contractor profiles suitable for the job posting and provide the list to the first user via the interface. If the first user selects an acceptable sub-contractor profile form the list, the processor creates a communication between a third user associated with the sub-contractor profile and the first user. The interface may be further configured to alert the third user of the selection of the first user. The third user then completes a job for the first user based on the job posting.

The method may include, as a next step, creating a job posting based on inputs from the first user. The job posting may then be analyzed by the computer system to create a list of sub-contractor profiles suitable for the job posting. The list may be provided to the first user via the interface. The next step may include alerting the third user associated with the sub-contractor profile and opening a communication between the first user and the third user if the first user selects the sub-contractor profile associated with the third user. Finally, a time is scheduled for the third user to complete the job for the first user.

In certain embodiments, the computer system further includes a memory configured to store details about the job completed. The method may further comprise the steps of generating a report after a predetermined time for a relevant time period, the report including the details about the job completed. The report is then provided to any user associated with the job completed. In certain embodiments the details about the job completed comprise the dates worked, a payment amount, and any expenses associated with the job. The method may further comprise the steps of compiling the report using details from any additional jobs performed by or for the user and creating a comprehensive report including details from all jobs associated with a user during the entire relevant time period. In certain embodiments, the comprehensive report may comprise all information required for the user to complete an individual or business tax return.

### Notes on Construction

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

FIG. 1 depicts a computer system according to certain preferred embodiments of the present invention;

FIG. 2 is a flow chart depicting a method according to certain preferred embodiments of the present invention;

FIG. 3 is a flow chart depicting an initial profile creation workflow for a contractor and a sub-contractor within a method according to an embodiment of the present invention;

FIG. 4 is a flow chart depicting a job creation and job selection workflow within a system according to an embodiment of the present invention;

FIG. 5 is a continuation of the flow chart depicting a job creation and job selection workflow of FIG. 4;

FIG. 6 is a continuation of the flow chart depicting a job creation and job selection workflow of FIG. 4; and

FIG. 7 is a flow chart depicting a payment and recordkeeping workflow within an application according to an embodiment of the present invention.

### DETAILED DESCRIPTION

The description of the preferred embodiment of the invention is intended to be read in connection with the accompanying drawings, which are to be considered part of the entire written description of this invention. The drawing figures are not necessarily to scale, and certain features of the invention may be shown exaggerated in scale or in somewhat schematic form in the interest of clarity of conciseness.

As discussed herein, the present invention is directed to systems and methods for locating and matching potential employers with potential employees and for generating and managing certain employment-related relationships, files, and documents. The systems and methods disclosed herein may be applied in any context or industry and have been found to be particularly useful in the construction industry. As such, in the description that follows, examples of the systems and methods of the present invention are described in relation to the construction industry. More specifically, in the description that follows, the systems and methods of the present invention are embodied as a software as a service (“SAAS”) platform or mobile application (“app”) to aid employers (e.g., contractors) seeking employees (e.g., sub-contractors) and to aid employees seeking employment. Within the app, contractors can preferably view available sub-contractors and post jobs, and sub-contractors can view available jobs and accept work proposals from contractors. In addition, the app will catalog a hiring history and a working history of both the contractor and the sub-contractor, and, at a designated time, issue tax documents related to the specific work performed.

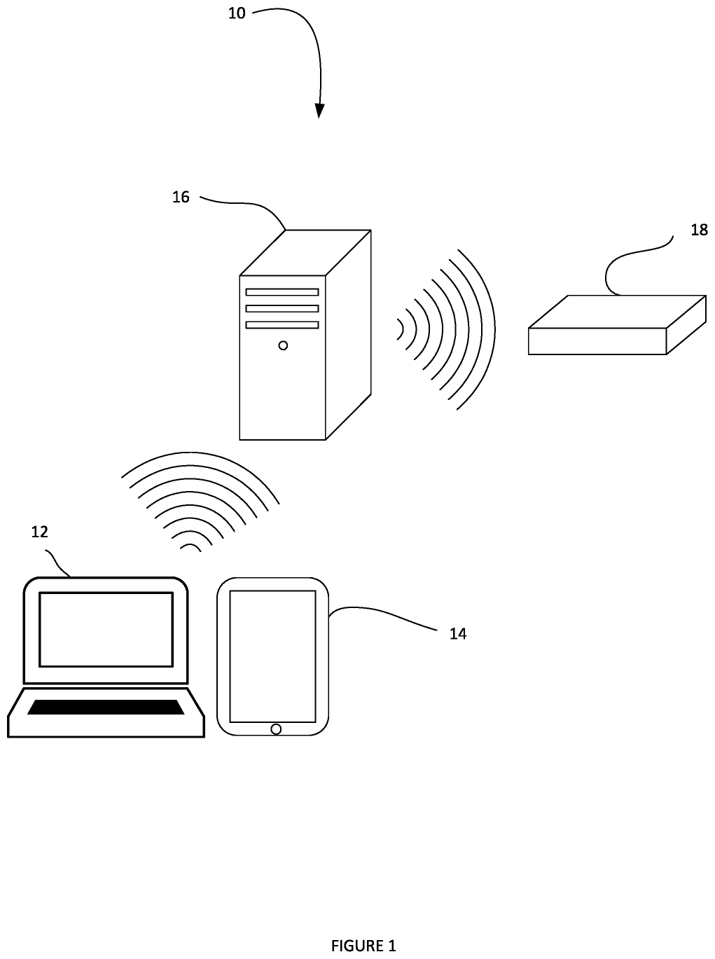

FIG. 1 depicts a computer system 10 for facilitating hiring and payment of a sub-contractor according to an embodiment of the present invention. The computer system 10 comprises an interface 12 or mobile interface 14, a processor 16, and a memory 18. In certain embodiments, the mobile interface 14 is a mobile telephone. The computer system 10 utilizes various inputs from a user to facilitate the method disclosed.

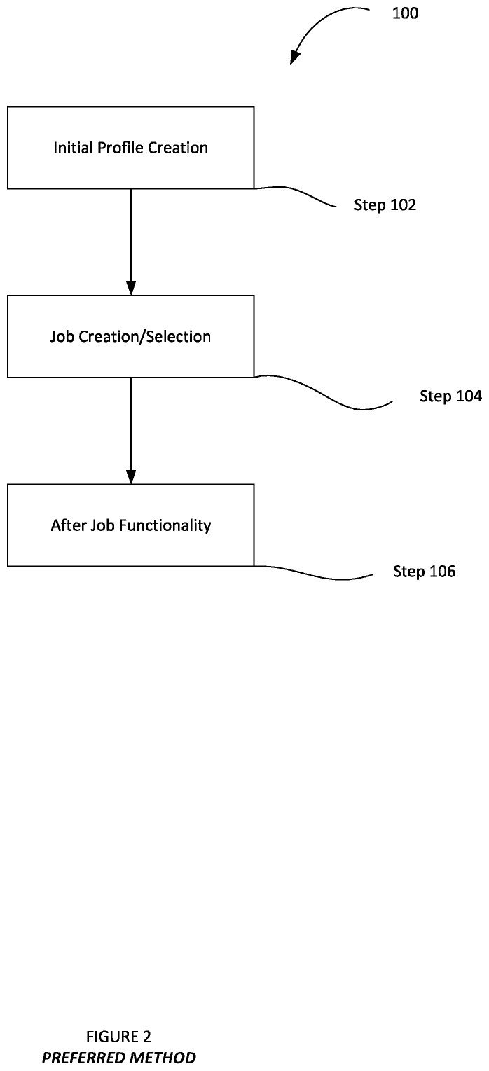

As shown in FIG. 2, a method 100 for linking a worker, typically a sub-contractor, with someone seeking a worker according to an embodiment of the present invention is shown. Preferably, the individual seeking a worker is a contractor. In certain instances, the method 100 utilizes a system. In certain embodiments, the system includes an interface and a processor, both being in electronic communication with the other and capable of receiving inputs from a user. The method 100 includes an initial profile creation Step 102, Job Creation/Selection Step 104, and After Job Functionality Step 106. Each step will be explained in further detail below.

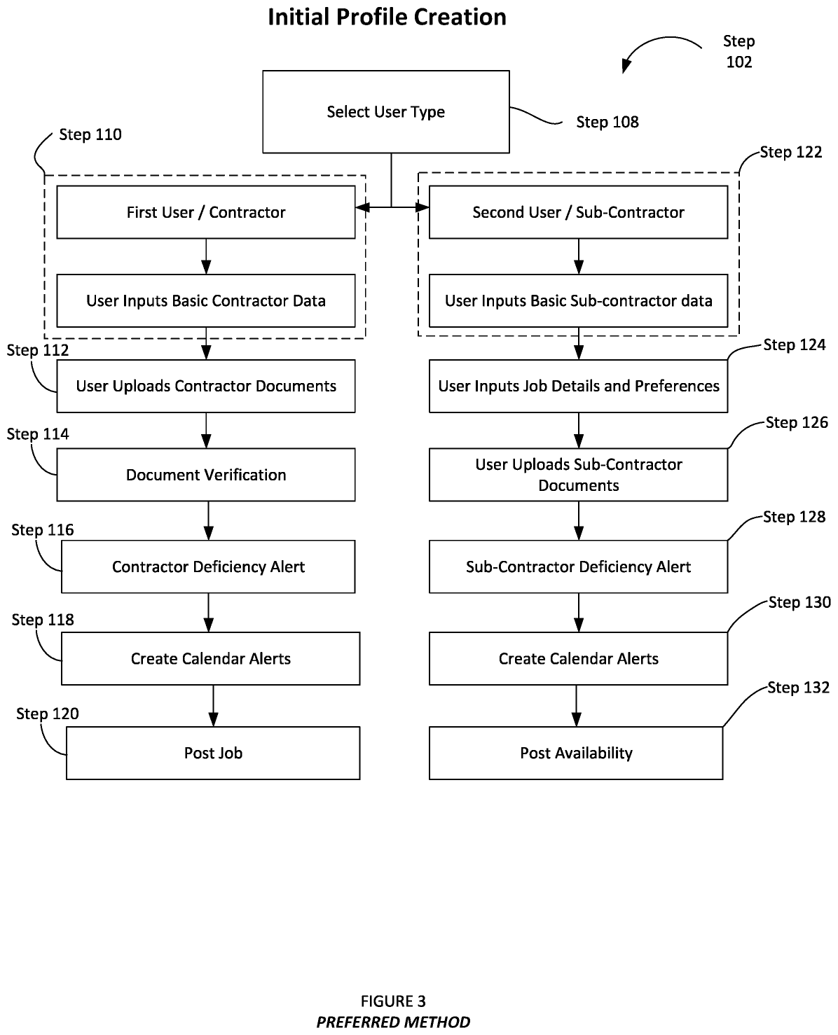

As shown in FIG. 3, the method 100 includes a process for initializing profiles for contractors and sub-contractors within a system. In preferred embodiments, a user must create an initial profile Step 102 and upload certain documents (e.g., PDF copies of tax documents, driver's license, insurance documentation, etc.) before being permitted to browse or submit jobs. In certain embodiments, all the foregoing is exchanged with the system via the interface. The system will generally have two types of users: Contractors seeking to hire and sub-contractors looking for work. The user will first select their preferred user type Step 108 and then will input information based on the user type selected.

A first user may be those seeking to hire (e.g., contractors). The first user will initially input basic data Step 110. For example, the contractor may input name, business name, address, phone number, email, and any tax information. A contractor may also include the type of work they generally need to have performed (e.g., plumbing, electrical, home building, commercial building, carpentry, painting, etc.). Via the interface, the contractor will then upload contractor documents Step 112 related to the business. These documents preferably include, but are not limited to, any relevant licenses (e.g., business or contractor licenses), W-9 forms or any other related tax documents, insurance documents, specialty certifications, etc. After uploading the documents, the processor then performs a verification of the uploaded documents Step 114 to check for deficiencies (e.g., missing, or incorrect documents or information). This verification Step 114 is preferably automated if possible or is performed by an app administrator. The verification Step 114 may involve third-party agencies, such as state licensing agencies. In certain embodiments, verification occurs by comparing the content or type of a submitted document against an expected content or type of document. If any deficiencies in the required paperwork are discovered, the contractor is preferably automatically alerted via the interface Step 116 and given a chance to cure those deficiencies. The app, or an app administrator, as a service for the contractor, can also complete any deficient paperwork. In certain embodiments, if the contractor's insurance is defective, the app will offer the option to purchase insurance specific to the general type of work specified by the contractor. The processor communicates with a third-party insurer to facilitate the purchase of any insurance. Any insurance purchases can be completed using the interface. After all relevant documents are uploaded and verified Steps 112, 114, the contractor is ready to post a job or find a sub-contractor Step 120.

Profile creation Step 102 for a second user is similar to profile creation for the first user, with some notable differences. In certain embodiments, the second user is someone seeking work, i.e., a sub-contractor. At the outset, the sub-contractor will select the “user type” Step 108 Sub-Contractor. The sub-contractor then inputs basic data Step 122, such as name, business name (if applicable), contact information, and any tax information. The sub-contractor will then input the job details and preferences Step 124, including the various types of work they perform, in certain instances from a predetermined list. For each type of work performed, the sub-contractor will indicate an experience level. References may be required for certain work types and experience levels. The sub-contractor will state the distance, or travel radius, they are willing to travel for a job. Finally, the sub-contractor will input any equipment relevant to their work areas (e.g., scaffolding, drone, paint sprayer, generator, compressor, etc.).

After inputting data related to the job type Step 124, the sub-contractor will upload any relevant documents Step 126 via the interface. Relevant documents for any user may include, but are not limited to, any licenses, tax documents, W-9, 1-9, citizenship information, insurance documents, and specialty certifications. The processor then verifies the uploaded documents, such as with the relevant third-party, either by electronic means or by providing the documents to an administrator. If any deficiencies are present, the processor provides an alert to the interface, alerting the sub-contractor of the deficiency Step 128. If the sub-contractor does not have appropriate insurance, the method may include the step of offering the option to purchase insurance specific to the sub-contractor and the job to be performed. In preferred embodiments, a third-party insurer provides the insurance, but the processor preferably facilitates the selection and purchase of the insurance. After all relevant information and documents are uploaded and verified, the sub-contractor can then post availability Step 132 and look for work and accept jobs.

In addition to the above, in certain embodiments, the processor may calendar relevant dates related to the uploaded documents, e.g., expiration dates. This applies to both sub-contractors Step 130 and contractors step 118. As the processor detects an approaching relevant date, a reminder is preferably sent to the relevant party via the interface, by email, by text, etc. If the appropriate action is not taken before the relevant date, e.g., the license or insurance is not renewed, the processor may disable the user profile. In certain further embodiments, the processor may re-verify the uploaded documents at periodic intervals to ensure the continued validity of said documents. For example, if connected to an external system (e.g., a database storing licensure information), a request may be sent by the processor to that external system for verifying information (e.g., confirmation that a license is still active).

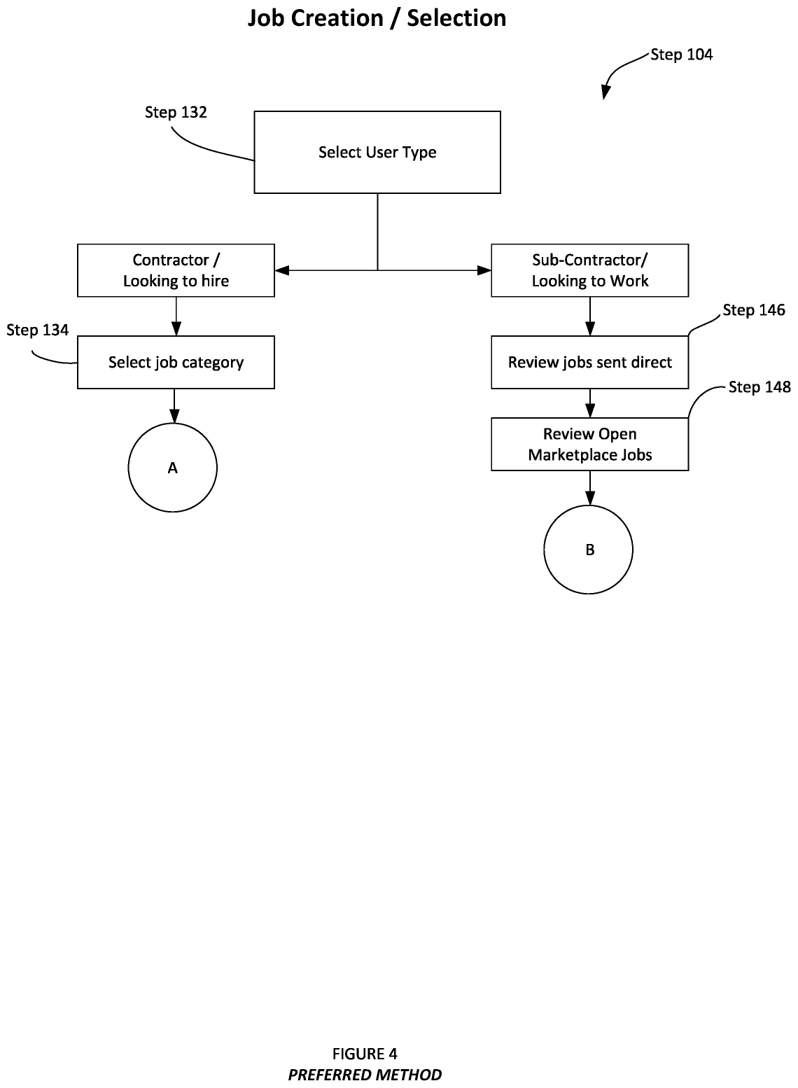

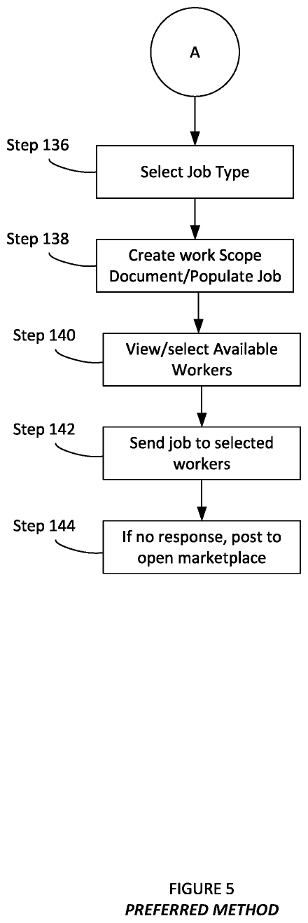

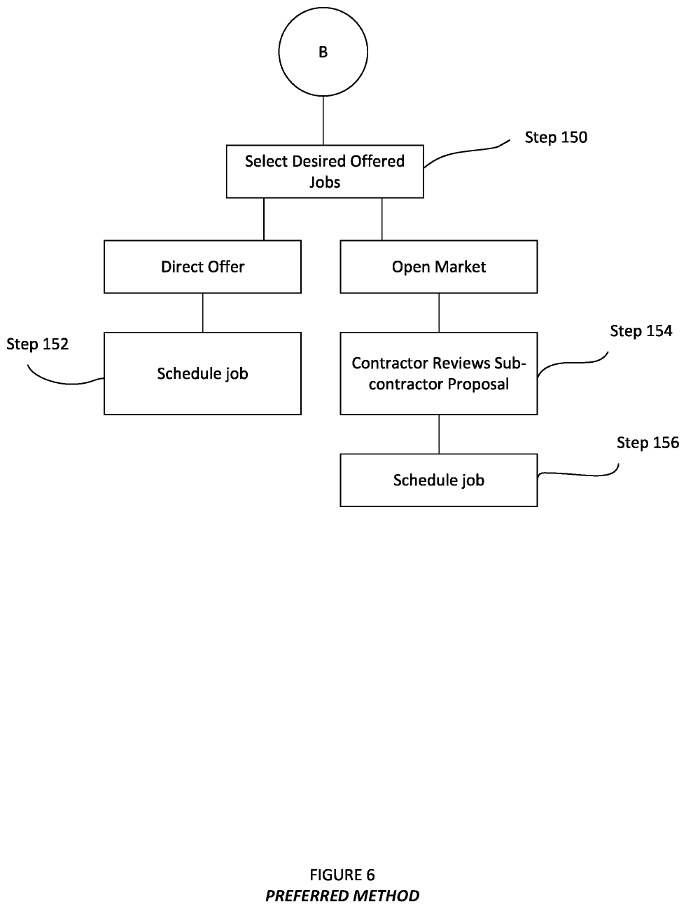

Turning now to FIGS. 4-6, a process for job selection and creation workflow Step 104 is shown. The process is similar for the contractor and the sub-contractor, but each will be described individually. In certain embodiments, via the interface, the user will select the user type Step 132, however, in certain other embodiments, the user type is associated with the user's profile. Beginning with the contractor, at the outset, the contractor selects a job category Step 134. In certain embodiments, job categories include large task groups like electrical, plumbing, painting, carpet, flooring, landscaping, etc. The contractor then selects the job type Step 136. In certain embodiments, the job type may be hourly (i.e., paid by the hour), daily (i.e., paid by the day) or fixed price (i.e., paid by the job). After the job type Step 136 is selected, the process of job creation is largely the same for all types of job.

Next, contractor creates a work scope document Step 138. The interface may populate recommendations for the work scope document based on the job category. Alternatively, the contractor may complete the work scope document from scratch. The work scope document allows potential sub-contractors to accurately know the amount of work required for a specific job. The more detailed a work scope document, the more helpful it will be to the sub-contractor. For example, a work scope document may read:
Job Description: The job consists of applying 2 coats of paint to the ceiling, walls, baseboard, and 2 doors (both sides) of a living room. Room floor size is 16 ft×14 ft. Wall height is 9 ft. Labor only, sub-contractor must supply own materials. Recommended materials include applicators, brushes, rollers, drop cloths, and step ladder.
Pay rate: $400.
Time estimate: 8 hours over 2 days.
Available dates: March 10-April 1.
Address: 123 Street Dr. City, State, 12345

After the work scope document is created, the processor populates the job based on the specific details from the work scope document. The processor then matches the job to sub-contractor profiles where the sub-contractor's profile meets the conditions required by the work scope document. The contractor is then provided, via the interface, a list of sub-contractors fitting the specifics of the job (e.g., job category, skillset, experience level, availability, and location). The contractor may then view the list and select their top worker preferences Step 140. In certain embodiments, the contractor can offer the job directly to a select number of sub-contractors Step 142. In this instance, if a sub-contractor accepts the job (as explained later), the processor rescinds any outstanding job offers for the same job. If no sub-contractor selects the job after a specified time, or the contractor does not have any preferential sub-contractors, the contractor can post the job to an “open marketplace” Step 144. Once posted on the open marketplace, any sub-contractor can review and express interest in the job.

Now turning to the sub-contractor, after creation of the sub-contractor's initial profile via the interface, the sub-contractor can now view, receive, and express interest in specific jobs. When the sub-contractor views the interface, any job offers sent directly from a contractor are displayed at the outset. The sub-contractor will review those jobs Step 146. If the sub-contractor is not interested in any direct job offerings, the sub-contractor can also browse the open marketplace Step 148. Once a sub-contractor finds a job they are interested in either from a direct offering or from the open marketplace, the sub-contractor selects the job Step 150. If the job is a direct offering, the sub-contractor can accept the job as presented. The processer then creates a communication between the contractor and the sub-contractor to schedule the work Step 152. In certain embodiments, the sub-contractor may also propose changes in the job scope to the contractor. A change may include different payment amount, different allotted time, altering the dates of availability, or any other suitable change. The contractor will then review the changes and come to a resolution with the sub-contractor or continue to look for another suitable sub-contractor if the two parties cannot reach a resolution. All communications are initiated via the interface. In certain embodiments, all communications are recorded by the system.

If a sub-contractor expresses interest in a job from the open marketplace, the contractor performs additional steps before selecting the sub-contractor for the job. In certain embodiments, the processor matches the preferences of the sub-contractor with jobs on the open marketplace and provides the sub-contractor with a list of matching jobs via the interface. As the sub-contractor browses the list via the interface, they can express interest in jobs fitting their skillset, location, pay range, etc., by sending the contractor an offer to work using the interface. As the sub-contractor expresses interest, the interface sends an alert to the contractor or an alert may be sent via other means (e.g., email, text, etc.). The contractor then reviews the sub-contractor's profile and determines if the sub-contractor is suitable for the job Step 154. If the contractor deems the sub-contractor suitable for the job, the offer for work is accepted and the sub-contractor and contractor are placed in communication via the interface to schedule the job Step 156. In addition to accepting the job as proposed, the sub-contractor is also given the option to propose modifications to the scope of work, e.g., pay rate, timeline, equipment requirements, etc. In certain instances, the contractor will publish a scope of work with no pricing information and sub-contractors will submit bids on the specific job. The processor then ranks the bidding sub-contractors based on terms, work history of the sub-contractor, or other relevant factors. The ranking is made into a list and may be provided to the contractor via the interface. The contractor may then accept the preferred bid and schedule the work (or the work may be scheduled automatically by the system). For example, in certain cases, each party might provide scheduling preferences and, based on a match between those preferences, the nature of the work (e.g., how long the work will require), the requirements of the work (e.g., availability of resources), or other requirements of the work (e.g., time to obtain a license or schedule an inspection), the system may schedule the work automatically or may provide a recommended scheduling. In certain other embodiments, the system may propose a schedule based on a sub-contractor's pre-existing system-facilitated work requirements. For example, the system may optimize a sub-contractor's time and location based on the proximity to other jobs and the specific time required for each task. In the instance of a painter, the system may suggest a sub-contractor schedule allowing the painter to complete other, nearby jobs while paint is drying at the original job.

Throughout the job creation/selection process, the system may offer a variety of ancillary services. For example, if a sub-contractor is uninsured and expresses interest in a job, the processor connects the sub-contractor with an insurance company and offers the sub-contractor insurance for the specific job via the interface. Also, if any equipment is needed for the job (either rented or purchased), an option to purchase or rent the equipment may be offered. In each of these cases, the ancillary services might require the participation of a third party (e.g., insurance provider or rental equipment provider). Preferably, the system is configured to communicate with these third parties and to coordinate the necessary transactions (e.g., negotiating an equipment rental or insurance contract) using the specifics of the job (e.g., location, time, etc.). The processor will also catalog any sub-contractors with unique certifications. If a contractor posts a job requiring those certifications, the processor will also populate a list of sub-contractors having those certifications (e.g., fork-lift drivers, inspectors, commercial driver's license holders, etc.). Finally, the system may also facilitate the purchase of any supplies required for a job (e.g., paint, drywall, lumber, spackle, wiring, piping, masonry, etc.). Again, this purchase may be facilitated via an interaction between the system and a third party (e.g., local paint, hardware, or supply store).

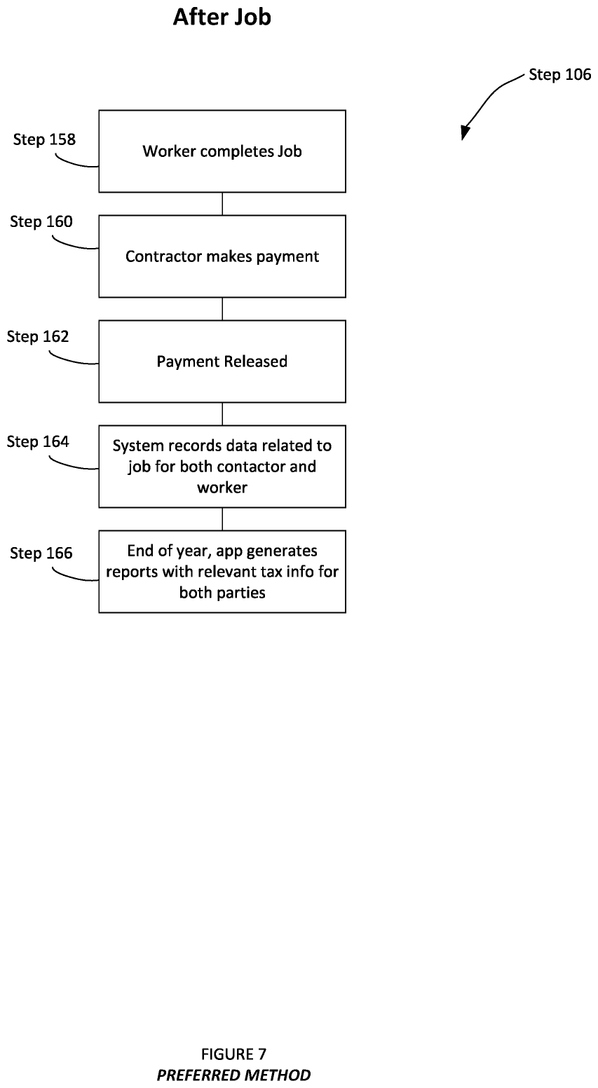

FIG. 7 depicts an after-job workflow process that may be undertaken by the system of the present invention after a job has been completed. In this process, the sub-contractor first completes the job Step 158. The contractor then makes payment to the sub-contractor Step 160, preferably utilizing the interface. In certain embodiments, the contractor may optionally or may be required to place the payment in a system-enabled escrow account prior to the job beginning. One prevalent issue in the construction industry is non-payment or heavily delayed payment by a contractor. Placing the payment in an escrow account will guarantee the sub-contractor prompt payment upon completion of the job. This payment processing may also be handled or facilitated by a third party (e.g., a payment processing entity) that works cooperatively with the system. In certain cases, once the payment is made or released, a portion of the payment (e.g., 75% or some other amount) goes to the sub-contractor and another portion (e.g., 25% or some other amount) of the payment is held back by the system Step 162 to account for certain expenses associated with the job (e.g., license fees, taxes, insurance, etc.). The processor then records all data related to the job, including the identity of the contractor and the sub-contractor Step 164, the time and amount of payment, the date of completion, the manner of payment, etc. This data may also include dates worked, vacation days, materials or supplies purchased via the system, any insurance purchased via the system, notes from the contractor regarding job performance, etc. At the end of the year, the processor compiles all data for each user and their use of the system to provide or work jobs, including information related to jobs posted, jobs worked, sub-contractors hired, etc. The processor then generates reports for all users and sends a copy of the report to the user Step 166, preferably electronically. This report may be a FORM 1099. This report may include any information stored by the system, including tax information related to any jobs completed, payment amounts, the names or identities of parties involved, information related to taxes (e.g., withholdings, deductions, credits, etc.). Specifically, if cataloged, reported and/or purchased utilizing the interface, the report includes mileage data (e.g., based on a “home” location and the location of jobs), tool costs, and other material costs. The processor can also facilitate communication with a tax professional familiar with the construction industry.

In certain embodiments, the system includes more functionality for varying aspects of the construction industry. For example, beyond helping contractors find sub-contractors, the app will preferably facilitate connections and employment for jobs ancillary to a main or primary job. For example, if a primary job relates to hiring contractors to construct a building, ancillary jobs may include hiring inspectors to inspect the building, hiring realtors to sell the building, hiring title companies to process the sales transaction, hiring loan officers to finance the building and sale of the building, and hiring attorneys to assist sub-contractors, contractors, or realtors as needed. Preferably, this system may be configured to assist in each of these aspects of the job.

In certain embodiments, the system includes other notable features. For instance, the system may employ machine learning (i.e., artificial intelligence or AI) to transform data into meaningful job prediction and cost estimator tools. AI may also be used to make certain predictions or recommendations to users. For instance, after a sub-contractor completes a job, the system may catalog the time and costs involved with the job and then, based on that catalogued data, offer suggestions to that same contractor and/or other contractors for other similar jobs related to the average time or costs involved (or other relevant or helpful information, e.g., licenses needed or equipment that is helpful). In addition, the system may catalog any discrepancies between the quoted work scope and the finished project. The system may further catalog any jobs commonly associated with others. For example, the system may note the frequency of painting jobs preceded by drywall jobs. As the system builds a database containing this various data, the system will begin to generate suggested work scopes to contractors placing jobs. For example, a contractor may be able to post a work scope for a drywall project and the processor will auto populate and suggest a work scope for the flooring, painting, and any other jobs required to complete an overall finished project. In addition, the system may be able to create checklists and schedules for larger projects based on predictive analysis utilizing AI. AI may also be useful to allow translation of a job posting to the native language of an interested party. AI may also be useful during verification of uploaded documents and to prevent fraudulent postings. Finally, AI may be employed to quickly filter sub-contractors meeting the requirements of a job.

Although this description contains many specifics, these should not be construed as limiting the scope of the invention but as merely providing illustrations of the presently preferred embodiment thereof, as well as the best mode contemplated by the inventor of carrying out the invention. The invention, as described herein, is susceptible to various modifications and adaptions, as would be understood by those having ordinary skill in the art to which the invention relates.

What is claimed is:

1. A computer system for facilitating hiring and payment of a sub-contractor, comprising:
an interface operable to:
electronically receive inputs from a plurality of sub-contractors to create a plurality of sub-contractor profiles, the sub-contractor inputs comprising:
basic identification information;
relevant tax documentation;
an employability status;
a skill-set identification including experience levels;
relevant licensure documents; and
an indication of appropriate travel distance, and
electronically receive inputs from a first user to create a job posting, the user inputs comprising:
a scope of work;
an experience level requirement;
an equipment requirement; and
an insurance requirement;
a processor configured to receive the sub-contractor inputs and the user inputs from the interface and further configured to:
electronically confirm and verify the sub-contractor inputs with a relevant third-party;
refuse creation of the sub-contractor profile if any sub-contractor inputs are unable to be verified until the sub-contractor provides a verifiable sub-contractor input and alert a second user, the second user being associated with the sub-contractor profile;
analyze the job posting to create a list of sub-contractor profiles suitable for the job posting; and
provide the list to the first user via the interface, and
wherein if the first user selects an acceptable sub-contractor profile from the list, the processor creates a communication between a third user associated with the sub-contractor profile and the first user,
wherein the interface is further configured to alert the third user of the selection of the first user, and
wherein the third user completes a job for the first user based on the job posting.

2. The computer system of claim 1 wherein if the acceptable sub-contractor profile is not located or selected the processor places the job posting on a database for sub-contractors to view via the interface,
wherein a fourth user may express interest in the job posting by sending an alert to the first user,
wherein the first user may review a sub-contractor profile of the fourth user,
wherein if the first user finds the fourth user acceptable for the job posting, the processor creates a communication between the fourth user and the first user and sends an alert to the fourth user, and
wherein the fourth user completes a job for the first user based on the job posting.

3. The computer system of claim 1 further comprising a memory, the memory configured to store details about the job completed, and
wherein after a predetermined period of time, the processor generates a report including the details about the job completed and provides the report to any user associated with any job completed.

4. The computer system of claim 3 wherein the details about the job completed comprise dates worked, a payment amount, and any expenses associated with the job.

5. The computer system of claim 4 wherein the report comprises a FORM-1099.

6. The computer system of claim 1 wherein the processor is further configured to re-confirm and re-verify the sub-contractor inputs at pre-determined time intervals, and
wherein if the sub-contractor inputs cannot be re-confirmed or re-verified, the processor sends an alert to the user associated with the sub-contractor profile via the interface, and the user is unable to interact with the job postings until the inputs are corrected and re-confirmed or re-verified.

7. The computer system of claim 1 wherein the processor further comprises a payment function, and
wherein upon completion of the job, monetary funds are transferred from the first user to the third user.

8. The computer system of claim 7 wherein a portion of the monetary funds are retained by the computer system.

9. The computer system of claim 8 wherein the processor communicates with an escrow account service,
wherein the first user places the monetary funds in the escrow account prior to a start of the job using the interface, and
wherein upon completion of the job, the funds are released and subsequently transferred to the third user.

10. A method for contract job management and documentation comprising:
providing a computer system having an interface for providing information to users, an input for receiving information from the users, a memory for storing instructions and also for storing information provided to or received from the users, a processor for processing information stored to the memory and for providing instructions and information stored to the memory or that is based on the information stored to the memory and that is provided to the user via the interface;
with the computer system, receiving and storing to the memory contractor information and creating a contractor profile based on and associated the contractor information;
with the computer system, receiving a contract job description and at least one job requirement, including at least one tax-related requirement, for a contract job and associating the contract job description and at least one job requirement with the contractor profile;
with the computer system, receiving and storing to the memory sub-contractor information related to each of a plurality of sub-contractors and, for each of the plurality of sub-contractors, creating a separate sub-contractor profile based on and associated with the sub-contractor information relevant to that sub-contractor, wherein the sub-contractor profile includes at least one job preference;
with the computer system, requiring the contractor and plurality of sub-contractors to provide information to the computer necessary for satisfying each of the at least one job requirement including the at least one tax-related requirement;
with the computer system, based on the contract job description, the sub-contractor profiles, and the at least one job preference, attempting to match at least one of the plurality of sub-contractors to the contract and, if a match is made between the contractor job and a matching sub-contractor profile, providing the contractor with an identity of the contractor associated with the matching sub-contractor profile;
receiving with the computer system, an acceptance indicating that the contractor and one of the matching sub-contractors has agreed to contract for the contract job; and
with the computer system, for each contract where an acceptance has been received, automatically associating information that is received by the system and stored to the memory that is necessary to satisfy the at least one job requirement and the at least one tax-related requirement with at least one of the contractor profile and the sub-contractor profile.

11. The method of claim 10 further comprising: with the computer system, processing the contract job description in order to determine at least one job requirement, including at least one tax-related requirement, and issuing an instruction requesting information be provided to the computer system related to the at least one job requirement including the at least one tax-related requirement.

12. The method of claim 11 further comprising: with the computer system, processing the contract job description in order to identify one of said at least one said job requirement.

13. The method of claim 12 further comprising: with the computer system, after a predetermined time interval sending a report comprising the associated information stored in the memory to the associated contractor profile or sub-contractor profile.

14. A method for creating and managing tax documents for contractors in a construction industry, the method comprising the steps of:
providing a computer system for facilitating hiring and payment of a sub-contractor, comprising:
an interface operable to:
electronically receive inputs from a plurality of sub-contractors to create a plurality of sub-contractor profiles, the sub-contractor inputs comprising:
basic identification information;
relevant tax documentation;
an employability status;
a skill-set identification including experience levels;
relevant licensure documents; and
an indication of appropriate travel distance, and
electronically receive inputs from a first user to create a job posting, the user inputs comprising:
a scope of work;
an experience level requirement;
an equipment requirement; and
an insurance requirement;
a processor configured to receive the sub-contractor inputs and the user inputs from the interface and further configured to:
electronically confirm and verify the sub-contractor inputs with a relevant third-party;
refuse creation of the sub-contractor profile if any sub-contractor inputs are unable to be verified until the sub-contractor provides a verifiable sub-contractor input and alert a second user, the second user being associated with the sub-contractor profile;
analyze the job posting to create a list of sub-contractor profiles suitable for the job posting; and
provide the list to the first user via the interface, and
wherein if the first user selects an acceptable sub-contractor profile from the list, the processor creates a communication between a third user associated with the sub-contractor profile and the first user,
wherein the interface is further configured to alert the third user of the selection of the first user, and
wherein the third user completes a job for the first user based on the job posting;
creating a job posting based on inputs from the first user;
analyzing the job posting to create a list of sub-contractor profiles suitable for the job posting;
providing the list to the first user via the interface;
alerting the third user associated with the sub-contractor profile and opening a communication between the first user and the third user if the first user selects the sub-contractor profile associated with the third user; and
scheduling a time for the job to be completed by the third user.

15. The method of claim 14 wherein the computer system further comprises a memory, configured to store details about the job completed and the method further comprises the steps of:
generates a report after a predetermined time for a relevant time period, the report including the details about the job completed; and
providing the report to any user associated with any job completed.

16. The method of claim 15 wherein the details about the job completed comprise dates worked, a payment amount, and any expenses associated with the job.

17. The method of claim 16 further comprising the steps of:
compiling the report using details from any additional jobs performed by or for the user; and
creating a comprehensive report including details from all jobs associated with a user during the relevant time period.

18. The method of claim 17 wherein the comprehensive report comprises all information required to complete an individual or business tax return.
